(19) United States
(12) Patent Application Publication
(10) Pub. No.: US 2022/0135819 A1
(43) Pub. Date: May 5, 2022

(54) INK COMPOSITIONS

(71) Applicant: Hewlett-Packard Development Company, L.P., Spring, TX (US)

(72) Inventor: Goeun SIM, Corvallis, OR (US)

(73) Assignee: Hewlett-Packard Development Company, L.P., Spring, TX (US)

(21) Appl. No.: 17/433,167

(22) PCT Filed: Oct. 21, 2019
(86) PCT No.: PCT/US2019/057185

§ 371 Date: Aug. 23, 2021

(51) Int. Cl. C09D 11/328; C09D 11/38; C09D 11/033; C09D 11/40; C08K 5/053; C08K 5/1535; C08K 5/06; C08K 5/42; C08K 5/00; B41J 2/21

(52) U.S. Cl. CPC C09D 11/328; C09D 11/38; C09D 11/033; C09D 11/40; B41J 2/2107; C08K 5/1535; C08K 5/06; C08K 5/42; C08K 5/0041; C08K 5/053

(57) ABSTRACT

An ink composition can include a dye and an ink vehicle. The ink vehicle can include water, from 1.5 wt % to 8 wt % of a C4-C6 1,2-alkanediol, and from 12 wt % to 25 wt % of a secondary co-solvent package including multiple co-solvents selected from 2-pyrrolidone, 1-(2-hydroxyethyl)-2-pyrrolidone, 2-methyl-1,3-propanediol, triethylene glycol, 1,5-pentandiol, 1,6-hexanediol, glycerol, or 5-dimethylhydantoin. The ink composition also includes a surfactant package including from 0.6 wt % to 1.6 wt % of the surfactant package, which includes both a nonionic surfactant and an anionic surfactant at a weight ratio from 4:1 to 1.5:1, for example.

### BACKGROUND

Since the inception of inkjet printing, applications for the use of digital printing with inkjet ink compositions have been expanding. As ink formulations become more complicated, higher resolution images with acceptable printability qualities have been fine-tuned based on their specific application parameters. In many instances, ink compositions designed for digital printing can provide acceptable print quality and other desirable traits, but the hardware, e.g., printheads, used with many inks are maintained mechanically via service stations, printhead nozzle capping, etc. However, with some types of printers, such as a handheld printer, there may be circumstances where there is limited servicing available for the inkjet printheads. Thus, formulation parameters for use in these types of printers may be unique to avoid poor decap performance, ink drooling, ink crusting or crystallization at the jetting orifice, and/or clogging, to name a few examples.

### BRIEF DESCRIPTION OF THE DRAWINGS

FIG. 1 schematically illustrates an example ink composition in accordance with the present disclosure;

FIG. 2 schematically illustrates an example ink set in accordance with the present disclosure; and

FIG. 3 is a flow chart illustrating an example method of printing in accordance with the present disclosure.

### DETAILED DESCRIPTION

The present disclosure relates to dye-based ink compositions which can be used for digital printing, and particularly in digital printing applications where printhead nozzles of a digital inkjet printer may not be frequently serviced or capped while in normal use. An example of such a printer may be a handheld printer with limited serviceability on board the printer while in handheld use. Ink compositions that may be prepared for use with such a printer may be of benefit if such inks could exhibit long decap times, e.g., greater than 5 minutes, greater than 10 minutes, or even greater than 20 minutes or 30 minutes, without crusting or clogging upon a subsequent use after a period of nonuse. Furthermore, an ink composition that could exhibit robust performance without spitting (another method to keep printhead nozzles clean), while exhibiting little (if any) puddling and/or unwanted aerosolization or printhead nozzle drooling, would be beneficial. Achieving one, a few, or all of these design characteristics could be beneficial for an inkjet printer with limited serviceability and/or capping, for example.

In accordance with the present disclosure, certain combinations of solvents and surfactants can be used to formulate an ink composition that has acceptable properties, even when printed from inkjet printhead nozzles with limited capping and/or servicing. An ink composition, for example, incudes a dye and an ink vehicle. The ink vehicle includes water, from 1.5 wt % to 8 wt % of a C4-C6 1,2-alkanediol, and from 12 wt % to 25 wt % of a secondary co-solvent package including multiple co-solvents selected from 2-pyrrolidone, 1-(2-hydroxyethyl)-2-pyrrolidone, 2-methyl-1,3-propanediol, triethylene glycol, 1,5-pentandiol, 1,6-hexanediol, glycerol, or 5-dimethylhydantoin. The ink composition also includes a surfactant package including from 0.6 wt % to 1.6 wt % of the surfactant package, which includes both a nonionic surfactant and an anionic surfactant at a weight ratio from 4:1 to 1.5:1, for example. In one example, the secondary co-solvent package can include from 4 wt % to 12 wt % of the 1-(2-hydroxyethyl)-2-pyrrolidone. In another example, the secondary co-solvent package includes from 4 wt % to 12 wt % glycerol. In still another example, the secondary co-solvent package can include form 4 wt % to 12 wt % triethylene glycol as well as from 1 wt % to 6 wt % tripropylene glycol methyl ether. In another example, the anionic surfactant can be an alkyldiphenyloxide disulfonate surfactant. In further detail, the nonionic surfactant can be a linear secondary alcohol ethoxylate surfactant having an HLB value less than 12. In another example, the dye can be yellow and the ink composition can further include sorbitol, xylitol, betaine, or a mixture thereof. In one specific example, the multiple solvents that can be used in the organic co-solvent package are selected from the group consisting of 1-(2-hydroxyethyl)-2-pyrrolidone, ethylhydroxy-propanediol, 2-methyl-1,3-propanediol, triethylene glycol, 1,5-pentandiol, 1,6-hexanediol, glycerol, and 5-dimethylhydantoin. In another example, the dye can be a sulfonated dye, for example.

In another example of the present disclosure, an ink set includes a cyan ink including a sulfonated cyan dye, a magenta ink including a sulfonated magenta dye, and a yellow ink including a sulfonated yellow dye. The cyan ink, the magenta ink, and the yellow ink independently have an ink vehicle including water, from 1.5 wt % to 8 wt % of a C4-C6 1,2-alkanediol. The ink vehicle also includes from 12 wt % to 25 wt % of a secondary co-solvent package including multiple co-solvents selected from 2-pyrrolidone, 1-(2-hydroxyethyl)-2-pyrrolidone, 2-methyl-1,3-propanediol, triethylene glycol, 1,5-pentandiol, 1,6-hextanediol, glycerol, or 5-dimethylhydantoin. The ink vehicle of this example also includes from 0.6 wt % to 1.6 wt % of a surfactant package including both a nonionic surfactant and an anionic surfactant at a weight ratio from 4:1 to 1.5:1. In one example, the cyan ink, the magenta ink, or both the cyan and the magenta ink can independently include from 4 wt % to 12 wt % 1-(2-hydroxyethyl)-2-pyrrolidone and from 4 wt % to 12 wt % of glycerol. In another example, the cyan ink, the magenta ink, or both the cyan and the magenta ink can independently include from 4 wt % to 12 wt % 1-(2-hydroxyethyl)-2-pyrrolidone, from 4 wt % to 12 wt % triethylene glycol, and from 1 wt % to 6 wt % tripropylene glycol methyl ether. In still another example, the yellow ink can include from 4 wt % to 12 wt % 1-(2-hydroxyethyl)-2-pyrrolidone, from 4 wt % to 12 wt % glycerol, and from 1 wt % to 5 wt % betaine.

In another example, a method of printing includes ejecting a first portion of an ink composition from an inkjet printhead, wherein the ink composition includes a dye and an ink vehicle. In this example, the ink vehicle includes water, from 1.5 wt % to 8 wt % of a C4-C6 1,2-alkanediol, and from 12 wt % to 25 wt % of a secondary co-solvent package including multiple co-solvents selected from 2-pyrrolidone, 1-(2-hydroxyethyl)-2-pyrrolidone, 2-methyl-1,3-propanediol, triethylene glycol, 1,5-pentandiol, 1,6-hextanediol, glycerol, or 5-dimethylhydantoin. The ink composition can further include from 0.6 wt % to 1.6 wt % of a surfactant package including both a nonionic surfactant and an anionic surfactant at a weight ratio from 4:1 to 1.5:1. The method in this example includes allowing the inkjet printhead to rest uncapped and unserviced for a time period of 10 minutes or more, and ejecting a second portion of the ink composition from the inkjet printhead, wherein the inkjet printhead is unclogged when the second portion is ejected. In one example, the ink composition can be fed to the inkjet printhead from a fluid reservoir that includes a polyurethane foam in contact with the ink composition while the ink composition is within the fluid reservoir.

In addition to the examples described above with respect to the ink compositions, the ink sets, and the methods of printing, various details are described herein in greater detail. It is noted, however, that when discussing the ink composition, the ink sets, or the methods of printing herein, these relative discussions can be considered applicable to the other examples, whether or not they are explicitly discussed in the context of that example. Thus, for example, in discussing a dye relative to the ink composition, such description is also relevant to the ink sets and the methods of printing, and vice versa.

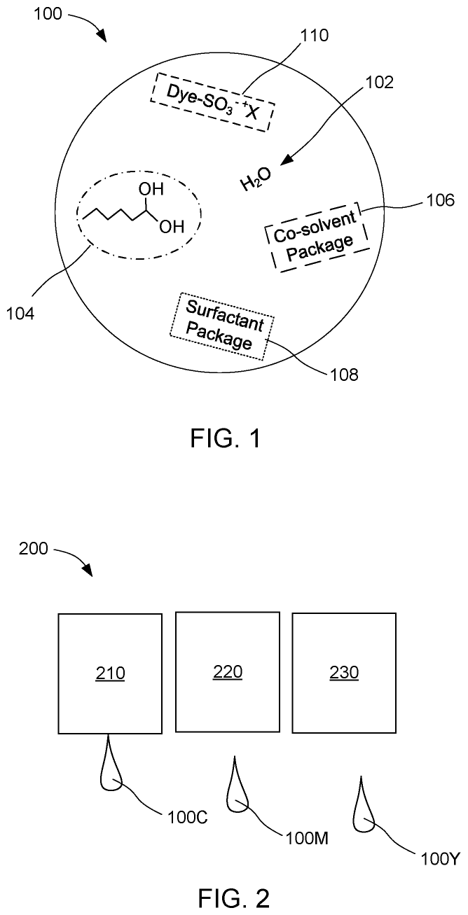

Referring now to FIG. 1, an ink composition 100 is shown that can include an ink vehicle and a dye 110, where X can be any monovalent counterion, such as an alkali metal, for example. The ink vehicle can include water 102, a C4-C6 1,2-alkanediol (shown by example in this particular FIG. as 1,2-hexanediol), a co-solvent package 106 that includes multiple co-solvents (in addition to the 1,2-alkanediol), and a surfactant package 108 that includes both a nonionic surfactant and an anionic surfactant. These various components are described in more detail hereinafter.

FIG. 2 depicts an example ink set 200 that can include multiple ink compositions that may be prepared as illustrated schematically in FIG. 1 and described further hereinafter. For example, the ink set can include a cyan ink composition 100C that can be housed or contained by fluid reservoir 210, a magenta ink composition 100M that can be housed or contained by fluid reservoir 220, and a yellow ink composition 100Y that can be housed or contained by fluid reservoir 230. These ink compositions can be formulated with the similar or different ink vehicles. If formulated differently, they can still be prepared in accordance with the ink composition formulations shown in FIG. 1 and described in greater detail herein. Furthermore, in some examples, the fluid reservoirs can be manufactured or prepared with polyurethane foams contained therein which may be in contact with the ink compositions, which can be included to control back pressure within the inkjet architecture. These ink compositions, for examples, can be formulated to have relative long decap times, e.g., a minimum of 1 minute, a minimum of 5 minutes, a minimum of 5 minutes, etc., or can exhibit even longer decap times, e.g., a minimum of 10 minutes, a minimum of 20 minutes, or a minimum of 30 minutes, etc. These ink compositions can also be formulated to be compatible with the polyurethane foams that may be present within the fluid reservoirs, for example.

### Dyes

The ink compositions described herein can be prepared with dyes as the colorant. The dyes, for example, can be sulfonated dyes that go into solution when admixed with the ink vehicles of the present disclosure, partly due to the sulfonate groups that can be associated with the dye molecules. Example dyes that can be used, for example, include sulfonated dyes such cyan, magenta, and yellow dyes from Nippon Kayaku (Japan), such as HC-B (cyan), HM-A (magenta), Y1189 (yellow), Y104 (yellow), H-YD-A (yellow), to name a few. Other example dyes that can be used may include dyes such as Acid Yellow 17, Acid Yellow 23, any of a number of sulfonated phthalocyanine dyes (e.g., cyan), sulfonated azo dyes (e.g., magenta), etc.

With some sulfonated water-soluble dyes, such as yellow dye Y1189, there may be printability issues related to causing growths or crystallization of the dye at the printhead where thermal energy is applied to eject the ink compositions from the printhead nozzles. If the particular dye exhibits crystallization (or printhead “bearding”), even small concentrations of such bearding can lead to nozzle health issues. Thus, a small concentration of an additive to reduce the rate of crystallization of such dyes can be added. However, since the ink compositions described herein are intended to have extended decap performance with minimal crusting, some additives cannot be used as they can significantly reduce decap performance. Thus, in accordance with an example of the present disclosure, a crystallization prevention agent, or a bearding additive, can be included with certain ink compositions that may be otherwise susceptible to bearding, such as from 1 wt % to 5 wt %, or from 2 w % to 5 wt % sorbitol, xylitol, betaine, or urea. Adding these crystallization prevention agent above about 5 wt % (based on a total weight of the ink composition), did not tend ameliorate bearding and/or ameliorate ink puddling, and did not tend to lengthen decap time. However, urea and betaine did not significantly negatively impact decap time. Sorbitol and xylitol, on the other hand, were still effective at reducing bearding as well as ink puddling, and also retained reasonable decap times (though reduced compared to ink compositions without the crystallization prevention agent). However, it was found that sorbitol and xylitol were not quite as effective as betaine. With urea, on the other hand, though they provided long decap times, it was not as practical of a choice, as it was less stable in an aqueous ink composition systems in several examples. Thus, the use of sorbitol, xylitol, or betaine (and particularly betaine) seemed to strike a good balance as a crystallization prevention agent suitable for controlling nozzle bearding, particularly with the yellow ink compositions, while still retaining longer decap times, e.g., greater than 10 minutes, greater than 20 minutes, and even greater than 30 minutes in some instances. In other examples, bearding can be ameliorated by the inclusion of certain kosmotropes, such as 0.1 wt % to 1 wt % of magnesium salt, soluble aluminum salt, soluble calcium salt, or a combination thereof. These additives may, at certain concentrations, reduce decap time, but with a target of decap times being a minimum of 1 minute, a minimum of 3 minutes, or even a minimum of 5 minutes, those additives can be added at concentrations sufficient to ameliorate bearding, while retaining relatively long decap times target minimum time, e.g., 1 minute, 3 minutes, or 5 minutes. Decap times of 1 minute, 3 minutes, or 5 minutes are considered relatively long decap times compared to most ink compositions of this type, which more typically have decap times in the range of a few seconds to 10 s of seconds, e.g., 12 seconds. However, the use of betaine to address yellow bearding still allowed the decap times to remain above 10 minutes, or even 20 minutes, for most examples.

### Ink Vehicles

The ink compositions, ink sets, and methods of printing described herein utilize ink vehicle components in providing long decap times, along with ink composition characteristics such as minimizing: pen drooling, aerosolizing, and/or puddling, etc. The ink vehicle as described herein can include water with a water content (based on the weight of the ink composition) from 50 wt % to 90 wt %, from 60 wt % to 90 wt %, or from 70 wt % to 85 wt %, for example. The ink vehicle can also include organic co-solvent, with multiple organic co-solvents being present in aggregate based on the weight of the ink composition at from 4 wt % to 30 wt %, from 8 wt % to 25 wt %, or from 10 wt % to 20 wt %, for example. Other ink vehicle components can also be included, such as surfactant. In accordance with the present disclosure, there can be both a nonionic surfactant and an anionic surfactant used, in combination, within a relatively narrow concentration range within a relatively specific weight ratio, e.g., from 0.6 wt % to 1.6 wt % at a weight ratio from 4:1 to 1.5:1.

### Organic Co-Solvents

With specific reference to the organic co-solvents that may be included in the ink compositions of the present disclosure, various individual organic co-solvents were evaluated to determine their individual impact on decap time using dye-based ink composition formulations in accordance with the present disclosure. In that evaluation, it was found that the presence of a C4-C6 1,2-alkanediol assisted with providing increased decap time, for example. Thus, 1,2-butanediol, 1,2-pentanediol, and/or 1,2-hexanediol provided a good combination of solubility or miscibility with respect to its inclusion in a water-based ink formulation, and also exhibited surfactant-like properties due to the two hydroxyl groups at one end of the compound, while the other end remained as a hydrocarbon chain. In particular, 1,2-pentanediol and/or 1,2-hexanediol were effective, and 1,2-hexanediol was particularly effective in the ink compositions of the present disclosure. The C4-C6 1,2-alkanediol can be included in the ink composition at from 1.5 wt % to 8 wt %, from 2 wt % to 7 wt %, form 2 wt % to 6 wt %, or from 3 wt % to 5 wt %, for example.

In addition to the C4-C6 1,2-alkanediol(s) that may be included, multiple organic co-solvents can be selected for inclusion in the ink composition, referred to herein as a “second co-solvent package.” The second co-solvent package includes all organic co-solvents included in the ink composition, other than the C4-C6 1,2-alkanediol(s) referred to previously, which is separated out into its own category of organic co-solvent. In further detail, in accordance with examples herein, the second co-solvent package includes multiple organic co-solvents selected from 2-pyrrolidone; 1-(2-hydroxyethyl)-2-pyrrolidone; 2-methyl-1,3-propanediol; tetraethylene glycol; triethylene glycol; 1,5-pentanediol; 1,6-hexanediol; glycerol; or 5-dimethylhydantoin. Thus, there can be two, three, four, etc., organic co-solvents from this list, but there may also be other organic co-solvents present that are not listed (over and above the multiple organic co-solvents listed above). The secondary co-solvent package, in total organic co-solvent aggregate, can be included in the ink composition at from 12 wt % to 25 wt %, from 14 wt % to 22 wt %, from 15 wt % to 20 wt %, or from 15 wt % to 25 wt %, for example.

In further detail regarding the ink vehicle, other organic co-solvents that can be included in addition to the co-solvents described above are alcohols, amides, esters, ketones, lactones, ethers, etc. In additional detail, organic co-solvents that can be used can include aliphatic alcohols, aromatic alcohols, diols, glycol ethers, polyglycol ethers, caprolactams, formamides, acetamides, etc. Examples of such compounds include primary aliphatic alcohols, secondary aliphatic alcohols, 1,2-alcohols (in addition to the C4-C6 1,2 alkanediols), 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, substituted or unsubstituted formamides, substituted or unsubstituted acetamides, or the like.

### Surfactant Packages

Referring now to the surfactants that can be included in the ink compositions of the present disclosure, the surfactants may be described in terms of a “surfactant package,” as there are multiple surfactants that are included in the present disclosure that work together, even synergistically in some examples, to generate long decap performance, as well as other performance enhancements, e.g., reduced puddling, reduced drooling, reduced aerosolized ink, etc. The two surfactants that may be included in the surfactant package include a nonionic surfactant and an anionic surfactant at a relatively narrow and low concentration in the ink composition, e.g., from 0.6 wt % to 1.6 wt % of total surfactant content (or surfactant package content) in the ink composition. In these examples, the nonionic surfactant and an anionic surfactant can be present within this weight percentage range at a weight ratio from 4:1 to 1.5:1, from 3:1 to 1.5:1, from 4:1 to 2:1, or from 3:1 to 2:1, for example.

Example nonionic surfactants that can be used include a number of surfactants sold under the trade name Surfynol®, e.g., Surfynol® 440 (from Evonik, Germany), or a Tergitol™, e.g., Tergitol™ TMN-6 or 15-S-7 (from Dow Chemical, USA). In one specific example, the nonionic surfactant can be a linear secondary ethoxylated alcohol, such as Tergitol™ 15-S-5, which can be particularly effective at enhancing decap performance. However, when added at too high of a concentration, it may have difficulty becoming solubilized in the ink vehicle formulation and in some instances, if at too high of a concentration, it can negatively contribute to ink bleed on the printed medium.

In further detail, considering Tergitol™ 15-S-5 and Tergitol™ 15-S-7 for comparison, both are effective at enhancing decap performance when included at the proper concentrations, and both are linear secondary alcohol ethoxylate nonionic surfactants. However, Tergitol™ 15-S-5 provides somewhat better (longer) decap performance than Tergitol™ 15-S-7. The HLB value of the Tergitol 15-S-7 is 12.1, and the HLB values of the Tergitol 15-S-5 is 10.5. Thus, there may be a connection between the HLB value and the surfactant choice for further enhancing decap performance. In connection with this, in one specific example, the HLB value of the nonionic surfactant can be than 12, e.g., from 8 to 12, or less than 11, e.g., from 9 to 11, though higher or lower HLB values can also be used, as illustrated by the slightly higher HLB value of Tergitol™ 15-S-7. “HLB” is an acronym for the hydrophilic-lipophilic balance of a compound, such as a surfactant, and can be calculated as a fractional ratio of hydrophilic and lipophilic parts of the surfactant. Griffin's method can be used to determine the HLB value, which has been established since about 1954. Griffin's method can be characterized by equation: HLB=20*Mₕ/M, where Mₕ is the molecular mass of the hydrophilic portion and M is the molecular mass of the entire molecule, giving a result on a scale from 0 to 20. An HLB value of less than 12

On the other hand, the anionic surfactant selected for use can be any of a number of anionic surfactants, such as phosphate ester of a C10 to C20 alcohol, polyethylene glycol oleyl mono phosphate, polyethylene glycol oleyl diphosphate, oleth-based phosphate, or a mixture thereof. One class of anionic surfactants that can be particularly beneficial in accordance with the present disclosure include sulfonated alkyldiphenyloxides. One example of a disulfonated alkyldiphenyloxide surfactant that can be used is Dowfax™ 2A1.

Without being limiting, but rather to show benefits of a combination of a nonionic and an anionic surfactant within the weight percentage and weight ratio ranges herein, the combination of Tergitol™ 15-S-5 (nonionic) and Dowfax™ 2A1 (anionic) is described by way of example. With this specific combination of surfactants, the nonionic surfactant can assist with both decap performance and reducing bleed, and the anionic surfactant can assist with putting the nonionic surfactant into solution. In further detail, the relative concentration of these two specific surfactants is shown in the Examples hereinafter.

### Other Additives

Consistent with the formulations of the present disclosure, various other additives may be included to provide desired properties of the ink composition for specific applications. Examples of these additives are those added to inhibit the growth of harmful microorganisms. These additives may be biocides, fungicides, and other microbial agents, which are routinely used in ink formulations. Examples of suitable microbial agents include, but are not limited to, Acticide®, e.g., Acticide® B20 (Thor Specialties Inc.), Nuosept™ (Nudex, Inc.), Ucarcide™ (Union carbide Corp.), Vancide® (R.T. Vanderbilt Co.), Proxel™ (ICI America), or a combination thereof. Sequestering agents such as EDTA (ethylene diamine tetra acetic acid) may be included to eliminate the deleterious effects of heavy metal impurities, and buffer solutions may be used to control the pH of the ink. Viscosity modifiers and buffers may also be present, as well as other additives to modify properties of the ink as desired.

### Methods of Printing

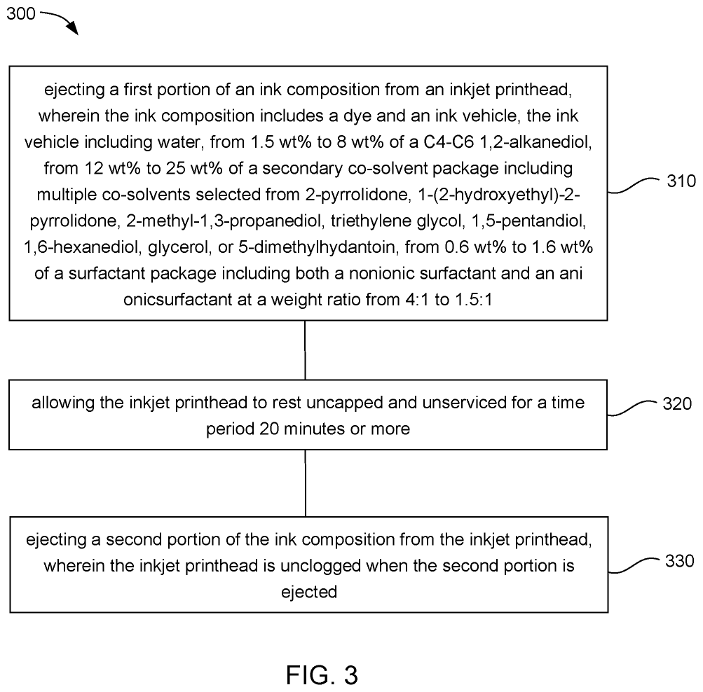

The present disclosure also establishes methods of printing in accordance with the present disclosure. In one example, as shown in FIG. 3, a method 300 of printing can include ejecting 310 a first portion of an ink composition from an inkjet printhead, wherein the ink composition includes a dye and an ink vehicle. In this example, the ink vehicle includes water, from 1.5 wt % to 8 wt % of a C4-C6 1,2-alkanediol, and from 12 wt % to 25 wt % of a secondary co-solvent package including multiple co-solvents selected from 2-pyrrolidone, 1-(2-hydroxyethyl)-2-pyrrolidone, 2-methyl-1,3-propanediol, triethylene glycol, 1,5-pentandiol, 1,6-hextanediol, glycerol, or 5-dimethylhydantoin. The ink composition can further include from 0.6 wt % to 1.6 wt % of a surfactant package including both a nonionic surfactant and an anionic surfactant at a weight ratio from 4:1 to 1.5:1. The method in this example can further include allowing 320 the inkjet printhead to rest uncapped and unserviced for a time period of 10 minutes or more, and ejecting 330 a second portion of the ink composition from the inkjet printhead, wherein the inkjet printhead is unclogged when the second portion is ejected. In another example, the inkjet printhead can be a thermal inkjet printhead assembled with a handheld printer, for example. In further detail, the ink composition can be fed to the inkjet printhead from a fluid reservoir that includes a polyurethane foam in contact with the ink composition while the ink composition is within the fluid reservoir.

### Inkjet Architecture Fluidics

In accordance with examples of the present disclosure, the ink compositions herein can be formulated to work well with digital printing inkjet technologies, such as with thermal inkjet printheads, piezo inkjet printheads, and the like. In one example, the inkjet printheads can be thermal inkjet printheads. In further detail, in one example, the fluid reservoir or ink tank used with the thermal inkjet printhead can be structurally assembled using an internal foam material within the reservoir for the purpose of controlling back-pressure of the architecture. In one example, the foam material can be a polyurethane foam.

Thus, in accordance with an example of the present disclosure, the inkjet printhead assemblies and fluid reservoirs used to evaluate the ink compositions of the present disclosure can include a fluid reservoir with a polyurethane foam structure therein. With this type of structure in particular, the polyurethane foam can selectively leach out or leach in certain components from the ink composition into the foam or from the foam into the ink composition, thus changing ink composition formulation slightly over time, and if changed in certain ways, sometimes altering the print performance. Non-volatile residues such as polyols and in some cases, surfactant, can be leached out from the foam and alter the ink properties to negatively impact the print performance including decap time. In another example, a number of hydrophobic entities in the ink composition, such as surfactant, dyes, organic solvents, can be adsorbed to the foam from the bulk ink, which can reduce the concentration of the surfactant, in particular, in the ink composition. Due to the surfactant loss from this adsorption, it may be useful to have some minor amount of additional surfactant present that still is at a concentration that provides acceptable long term decap time and other positive performance properties, but would continue to have good long term decap time and other positive performance properties after some surfactant has been adsorbed out into the polyurethane foam. Since the tolerances for the surfactant package is relatively tight, e.g., from 0.6 wt % to 1.6 wt % of surfactant package (in total) with both nonionic and anionic surfactant being included at a weight ratio from 4:1 to 1.5:1, the inkjet printhead assemblies and fluid reservoir components can be considered when formulating an ink composition that may be used over a period of time where adsorption (or some other chemical or physical modification) may have an impact. In the instant case where there may be a polyurethane foam in intimate contact with the ink composition, and where there may be some surfactant lost, then formulating the ink composition to within acceptable ranges, but starting near the top of the narrow range, may be a good approach for long term inkjet ink composition, printhead assembly, and/or fluid reservoir health.

On the other hand, an alternative way to ameliorate the surfactant loss to the polyurethane foam of the fluid reservoir is to use an organic co-solvent that is included at a much higher concentration than the surfactants in the surfactant package, but to select an organic co-solvent that will compete with the surfactant(s) with respect to being absorbed by the polyurethane foam.

Thus, by using the C4-C6 1,2-alkane diol as one of the organic co-solvents, this particular co-solvent not only helped with long term decap performance, but also allowed the surfactant loading to be pushed higher, thus pushing the equilibrium of the ink composition in the presence of the polyurethane foam so that the foam becomes saturated, thus decreasing the leaching effect. Thus, the use of somewhat hydrophobic 1,2-diols can help saturate the polyurethane foam with this organic co-solvent, which can lead to long term stability of the ink, as there may be reduced leaching of the unwanted foam residues from the foam and/or the surfactant loss of the ink to the polyurethane foam. Furthermore, in addition to being used to wet the polyurethane foam, the C4-C6 1,2-alkanediol co-solvent can also have a positive impact on reducing pen drooling.

Thus, as mentioned previously, the ink compositions of the present disclosure can include a C4-C6 1,2-alkanediol at a concentration from 1.5 wt % to 8 wt %. However, a secondary co-solvent package can also be present at from 12 wt % to 25 wt % that can also contribute to long term decap performance. For example, the secondary co-solvent package to be used with the C4-C6 1,2-alkanediol can be 1-(2-hydroxyethyl)-2-pyrrolidone and glycerol in one specific example, and in another specific example, the secondary co-solvent package can include 1-(2-hydroxyethyl)-2-pyrrolidone and triethylene glycol and tripropylene glycol methyl ether. Other combinations of organic co-solvents can be used to formulate the secondary co-solvent package.

It is to be understood that this disclosure is not limited to the particular process steps and materials disclosed herein because such process steps and materials may vary somewhat. It is also to be understood that the terminology used herein is used for the purpose of describing particular examples. The terms are not intended to be limiting because the scope of the present disclosure is intended to be limited only by the appended claims and equivalents thereof.

### Definitions

It is be noted that, as used in this specification and the appended claims, the singular forms “a,” “an,” and “the” include plural referents unless the context clearly dictates otherwise.

As used herein, a plurality of items, structural elements, compositional elements, and/or materials may be presented in a common list for convenience. However, these lists should be construed as though individual members of the list is individually identified as a separate and unique member. Thus, no individual member of such list should be construed as a de facto equivalent of any other member of the same list solely based on their presentation in a common group without indications to the contrary.

Furthermore, it is understood that any reference to open ended transition phrases such as “comprising” or “including” directly supports the use of other less open ended transition phrases such as “consisting of” or “consisting essentially of” and vice versa.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if individual numerical values and sub-ranges are explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc. Additionally, a numerical range with a lower end of “0” can include a sub-range using “0.1” as the lower end point.

### EXAMPLES

The following examples illustrate the technology of the present disclosure. However, it is to be understood that the following is merely illustrative of the compositions and methods herein. Numerous modifications and alternative methods and systems may be devised without departing from the present disclosure. Thus, while the technology has been described above with particularity, the following provides further detail in connection with what are presently deemed to be the acceptable examples.

### Example 1—Organic Co-Solvent Selection

Various individual organic co-solvents were evaluated to determine their individual impact on decap performance time in a dye-based ink composition in accordance with the present disclosure, and particularly to screen organic co-solvents for use with C4-C6 1,2-alkanediols in accordance with the present disclosure. Table 1 below shows the impact of specific individual organic co-solvents (screened initially herein as a single organic co-solvent system) at 10 wt % or at 20 wt %.

TABLE 1
Evaluation of Individual Organic Co-solvents and Decap Performance

| Ingredient | | | | |
|---|---|---|---|---|
| Description | Ingredients | | | wt % |
| Organic | 2-Pyrrolidone | 1,6-Hexanediol | TEG | 20 |
| Co-solvent | HE2P | Dantocol | DEG | |
| Tested | EHPD | 2,3-Butanediol | 1,3-Propaneglycol | |
| Individually | 1,5-Pentanediol | | Glycerol | |
| at 20 wt % | MPDiol | | TPM | |
| | TrEG | | | |
| Organic | 1,5-Pentanediol | 2P | TrEG | 10 |
| Co-solvent | 1,6-Hexanediol | HE2P | NMP | |
| Tested | Dantocol | MPDiol | DEG | |
| Individually | | TEG | Glycerol | |
| at 10 wt % | | EHPD | TPM | |
| Fixed Ink | 2-Ethane Sulfonic Acid (MES buffer) | | | 0.2 |
| Composition | Tergitol ™ 15-S-7 (Dow Chemical, USA) | | | 0.5 |
| Components | Cyan, Magenta, or Yellow Sulfonated Dye | | | 4 |
| | Water | | | Balance |
| *Decap | DT > 20 mins | 20 > DT > 5 mins | DT < 5 mins | |
| Time (DT) | | | | |
| in Minutes | | | | |

*DT was checked for the various solvents in 5 minute increments, and the individual organic co-solvents categorized based on three decap performance categories (DT > 20; 20 > DT > 5; and DT < 5) at two different loading concentrations (10 wt % or 20 wt %).
2P = 2-Pyrrolidone (2P)
MPDiol = 2-Methyl-1,3-propanediol
Dandocol = 5-Dimethylhydantoin
TrEG = Triethylene glycol
TPM = Tripropylene glycol methyl ether
HE2P = 1-(2-Hydroxyethyl)-2-pyrrolidone
TEG = Tetraethylene glycol
NMP = N-Methylpyrrolidone
DEG = Diethylene glycol

In accordance with Table 1, organic co-solvents that exhibited 5 minutes or more of decap time in the Formulations of Table 1 at either 10 wt % or 20 wt % were selected for further evaluation to establish a combination of organic co-solvents that could be used reliably with an inkjet printer or printhead that may not include a servicing station and/or which may be capped less frequently during use. Furthermore, some solvents exhibiting a decap time of less than 5 minutes were also further evaluated, as some can contribute to other printability and/or image quality properties. Many of these ink compositions, even after somewhat prolonged to very prolonged decap times, did not lead to nozzle clogging, as often occurs when not capping inkjet printing nozzles for extended periods of time. When referring to “clogging” or whether a nozzle is “unclogged,” what is meant is that for drops that are 5 ng or greater in size to be ejected from a printhead nozzle, the first attempted drop to be ejected is ejected properly and correctly. For drops that are from 2 ng to less than 5 ng in size, a nozzle that is unclogged is one which can be ejected at any of the first to third attempted firing of the inkjet pen.

### Example 2—Surfactant Package Selection

Two specific nonionic surfactants, namely Tergitol™ 15-S-7 and Tergitol™ TMN 6, and an anionic surfactant, namely Dowfax™ 2A1, were tested at various concentrations and evaluated for their effect on decap time within a range of about 0.6 wt % to about 1.6 wt %. Organic co-solvents chosen in this example were a few of the promising organic co-solvents found in the organic co-solvent screening study of Example 1. However, the purpose of this example is to illustrate how surfactant combinations and loading impact decap performance, bleed, and other printhead performance issues. The ink compositions prepared for decap testing are provided below in Table 2, as follows:

TABLE 2
Evaluation of Individual Surfactant and
Surfactant Packages and Decap Performance

| | Ink 1 | Ink 2 | Ink 3 | Ink 4 | Ink 5 |
|---|---|---|---|---|---|
| Ingredient | (Wt %) | (Wt %) | (Wt %) | (Wt %) | (Wt %) |
| 1-(2-Hydroxyethyl)- | 20 | 20 | 20 | 20 | 20 |
| 2-pyrrolidone | | | | | |
| (Organic Co-solvent) | | | | | |
| 1,6-Hexanediol | 5 | 5 | 5 | 5 | 5 |
| (Organic Co-solvent) | | | | | |
| Dowfax ™ 2A1 | 0.5 | 0.4 | — | — | — |
| (Anionic Surfactant) | | | | | |
| Tergitol ™ 15-S-5 | 1 | 0.9 | — | — | — |
| (Nonionic Surfactant) | | | | | |
| Tergitol ™ 15-S-7 | | | 0.5 | 1 | — |
| (Nonionic Surfactant) | | | | | |
| Tergitol ™ TMN 6 | — | — | — | — | 1 |
| (Nonionic Surfactant) | | | | | |
| Sulfonated Dye | 5.5 | 5.5 | 5.5 | 5.5 | 5.5 |
| Water | Balance | Balance | Balance | Balance | Balance |
| *Decap Time | 15 < DT < 20 | DT > 30 | DT > 30 | 5 < DT < 10 | 5 < DT < 10 |
| (DT) in Minutes | | | | | |

*DT was checked in 5 minute increments up to 30 minutes. Thus, decap time of greater than 30 minutes is likely and could be much higher.
Dowfax ™ surfactant is available from Dow Chemical (USA).
Tergitol ™ surfactant is available from Dow Chemical (USA).

In evaluating the various surfactant packages tested in accordance with the ink compositions of Table 2 above (Inks 1-5), Ink 1 had good long term decap performance at greater than 15 minutes but less than 20 minutes. Inks 2 and 3 exhibited excellent long term decap performance at greater than 30 minutes. However, with respect to Ink 3, there was not enough nonionic surfactant present to sufficiently ameliorate bleed for this particular ink, and thus, the ink was unacceptable for use due to bleed, area uniformity, and insufficient foam wettability, for example. Inks 4 and 5, on the other hand, exhibited somewhat acceptable long term decap performance, e.g., 5 to 10 minutes, but it is notable that by increasing the nonionic surfactant content from 0.5 wt % to 1 wt %, which did help with reducing bleed, this modification occurred at the expense of decap performance longevity. On the other hand, by adding a small concentration of anionic surfactant to the ink formulations (in addition to a larger concentration of the nonionic surfactant), the ink composition had much better bleed control and the decap performance time was lengthened. In further detail, in considering Ink 1 compared to Ink 2, though both provide good long term decap times and exhibit other good printability characteristics, by reducing the nonionic surfactant and the anionic surfactant concentrations by 0.1 wt % (10% reduction for the nonionic surfactant and a 20% reduction for the anionic surfactant), the decap time was considerably lengthened. Thus, though Inks 1 and 2 can both be prepared in accordance with examples of the present disclosure, Ink 2 represents an ink composition that is even further refined with respect to long term decap times, good bleed control, reduced aerosol or ink satellite droplets, reduced puddling, etc. In other words, Table 2 illustrates that within the parameters set forth in the present disclosure, even minor shift in the concentration of the surfactant or surfactant combination can have a relatively large impact on decap performance.

In further detail regarding selecting the surfactants, it is noted that the surfactant concentrations should be targeted to be from 0.6 wt % to 1.6 wt % of total surfactant content. As noted in Table 2 above, both nonionic and anionic surfactant can be admixed into a common surfactant package to provide both good decap performance while not introducing too much bleed, aerosolization, puddling, etc. However, it is also noted that including too much of a nonionic surfactant without adding some anionic surfactant to ameliorate some of the effect, there can be a significant decrease in decap performance time, e.g., >6 times decrease in decap time, as illustrated with Inks 3 and 4 where the nonionic surfactant was doubled and no anionic surfactant was added to assist with printability.

### Example 3—Selection of Organic Co-Solvents and Surfactant Packages for Use with Fluid Reservoirs with Polyurethane Foams

None of Inks 1-5 of Table 2 included a C4-C6 1,2-alkanediol as one of the organic co-solvents selected for use. However, in considering which organic co-solvents to use in the ink compositions of the present disclosure, ink compositions similar to Ink 2 were formulated to include a C4-C6 1,2-alkanediol, specifically 1,2-hexanediol, to take advantage of the surfactant-like nature of this solvent (with two hydroxyls at one end and a hydrophobic tail at the other end), as this was determined to be beneficial in ameliorating surfactant loss from the ink composition into polyurethane foam that can be present in some fluid reservoirs, e.g., included to control back pressure. More specifically, it was found that the surfactant lost from the ink into the polyurethane foam could be reduced when one of the organic co-solvents selected for use was a C4-C6 1,2-alkanediol.

### Example 4—Example Ink Compositions and Comparative Ink Compositions

In accordance with the data collected with respect to the organic co-solvents evaluated in Example 1, the surfactant packages evaluated in Example 2, and the amelioration of surfactant absorption into polyurethane foam of the fluid reservoirs that is aided by the inclusion of a C4-C6 1,2-alkanediol as described in Example 3, cyan, magenta, and yellow ink compositions were formulated that were found to exhibit long term decap time, little to no printhead drooling or ejection of aerosolized ink, little to no puddling, and which have good image quality generally. The three formulations are provided in Table 3 below in accordance with the present disclosure that are identified as Cyan, Magenta, and Yellow inks of an “Example Ink Set.” For comparison, a similar ink set with Cyan, Magenta, and Yellow inks was also evaluated as notated in Table 3 as “Comparative Ink Set.” The data collected in the comparison is shown in Table 3.

TABLE 3
Ink Composition and Ink Set Comparison

| | | Comparative Ink Set | | | Example Ink Set | | |
|---|---|---|---|---|---|---|---|
| Ingredient | | (wt %) | | | (wt %) | | |
| Description | Ingredient | Cyan | Magenta | Yellow | Cyan | Magenta | Yellow |
| C4-C6 1,2- | 1,2-hexanediol | | | | 3.3 | 3.3 | 3.3 |
| Alkanediol | | | | | | | |
| Organic Co- | 1,5-pentanediol | 8 | 8 | 8 | — | — | — |
| Solvent | HE2P | 6.5 | — | — | 8 | 8 | 8 |
| Package | 2P | — | 6.5 | 6.5 | — | — | — |
| | TrEG | — | — | — | — | 8 | — |
| | TPM | — | — | — | — | 2.5 | — |
| | EHPD | 7.5 | 7.5 | 7.5 | — | — | — |
| | Glycerol | — | — | — | 8 | — | 8 |
| Crystallization | Betaine | — | — | — | — | — | 2.5 |
| Prevention | | | | | | | |
| Agent | | | | | | | |
| Biocide | Proxel ™ GXL | 0.12 | 0.12 | 0.12 | — | — | — |
| Buffer | MES* free acid | 0.2 | 0.2 | 0.2 | 0.2 | 0.2 | 0.2 |
| Surfactant | Tergitol ™ 15-S-5 | 0.95 | 1 | 1 | 0.93 | 0.93 | 0.93 |
| Package | Tergitol ™ 15-S-7 | 0.95 | 1 | 1 | — | — | — |
| | Dowfax ™ 2A1 | — | — | — | 0.38 | 0.38 | 0.38 |
| | Dowfax ™ 8390 | 0.4 | 0.4 | 0.4 | — | — | — |
| Chelator | EDTA (Na₂) | 0.1 | 0.1 | 0.1 | — | — | — |
| Sulfonated | Cyan | 4.37 | — | — | 4.07 | — | — |
| Dyes | (Nippon Kayaku) | (JPD) | | | (HC-B) | | |
| | Magenta | — | 6.2 | — | — | 6.01 | — |
| | (Nippon Kayaku) | | (JPD) | | | (HM-A) | |
| | Yellow | — | — | 6.1 | — | — | 6 |
| | (Nippon Kayuku) | | | (Y1189) | | | (Y1189) |

| | | | | | | |
|---|---|---|---|---|---|---|
| Decap | 4 sec | 4 sec | 4 Sec | 30 min | 30 min | 20 min |
| Color Saturation | 3 | 3 | 3 | 3 | 3 | 3 |
| Yellow Bearding | N/A | N/A | 3 | N/A | N/A | 3 |
| Puddling | 3 | 3 | 3 | 3 | 3 | 3 |
| Aerosol | 1 | 1 | 1 | 2 | 2 | 2 |
| Mottle/Grain | 3 | 3 | 3 | 3 | 3 | 3 |
| Bleed | 3 | 3 | 3 | 3 | 3 | 3 |
| Uncapped Recovery | 1 | 1 | 1 | 3 | 3 | 3 |

Dowfax ™ surfactant is available from Dow Chemical (USA).
Tergitol ™ surfactant is available from Dow Chemical (USA).
Proxel ™ biocide is available form ICE America (USA).

In comparing the Example Ink Set of Table 3 against the Comparative Ink Set, also of Table 3, what is immediately apparent with the data collected is the length of time with respect to decap time. The decap time for the Comparative Ink Composition was about 4 seconds, whereas for the Example ink Compositions disclosed, the decap time was from about 20 minutes, which is about 300 times longer decap time relative to the Comparative Ink Composition. Decap was measured by printing the ink and leaving the nozzle heads both uncapped and unserviced and determining if recover could occur based on first firing (or first attempted drop ejected) for drops larger than 5 ng in size and within the first three firings for drops from 2 ng to 5 ng in size. In addition to this, other printability and image performance details were also compared based on a scale of 1 to 3, with a score indicating failure or poor performance, a score of 2 indicating acceptable or good performance, and a score of 3 indicating excellent performance. In accordance with this visual scoring, the ink compositions of the Example Ink Set performed better with respect to aerosolization (or lack thereof) and uncapped recover, e.g., recover of nozzle heath after leaving uncapped for a period of time sufficient to cause clogging. Other comparative printability and image quality scores were comparable.

Notably, with this comparison of ink sets, the ink compositions of the Example Ink Set all included a C4-C6 1,2-alkane diol, whereas the ink compositions of the Comparative Ink Set did not include a C4-C6 1,2-alkanediol. Furthermore, citing another comparative point, the surfactant package in the two ink sets were different. The total surfactant content in ink compositions in the Example Ink Set of Table 3 were all within the range of 0.6 wt % to 1.6 wt %, and the respective weight ratios of nonionic surfactant to anionic surfactant within those ink compositions was with the range of 1.5:1 to 4:1. On the other hand, the ink compositions of the Comparative Ink Set all had a total surfactant content greater than 1.6 wt %, and the respective weight ratios of nonionic surfactant to anionic surfactant were all outside the range of 1.5:1 to 4:1.

What is claimed is:

1. An ink composition, comprising:
a dye; and
an ink vehicle, including:
water,
from 1.5 wt % to 8 wt % of a C4-C6 1,2-alkanediol,
from 12 wt % to 25 wt % of a secondary co-solvent package including multiple co-solvents selected from 2-pyrrolidone, 1-(2-hydroxyethyl)-2-pyrrolidone, 2-methyl-1,3-propanediol, tetraethylene glycol, triethylene glycol, 1,5-pentandiol, 1,6-hexanediol, glycerol, or 5-dimethylhydantoin, and
from 0.6 wt % to 1.6 wt % of a surfactant package including both a nonionic surfactant and an anionic surfactant at a weight ratio from 4:1 to 1.5:1.

2. The ink composition of claim 1, wherein the secondary co-solvent package includes from 4 wt % to 12 wt % of the 1-(2-hydroxyethyl)-2-pyrrolidone.

3. The ink composition of claim 1, wherein the secondary co-solvent package includes from 4 wt % to 12 wt % glycerol.

4. The ink composition of claim 1, wherein the secondary co-solvent package includes form 4 wt % to 12 wt % triethylene glycol and wherein the ink composition also includes from 1 wt % to 6 wt % tripropylene glycol methyl ether.

5. The ink composition of claim 1, wherein the anionic surfactant is an alkyldiphenyloxide disulfonate surfactant.

6. The ink composition of claim 1, wherein the nonionic surfactant is a linear secondary alcohol ethoxylate surfactant having an HLB value less than 12.

7. The ink composition of claim 1, wherein the dye is yellow and the ink composition further includes sorbitol, xylitol, betaine, or a mixture thereof.

8. The ink composition of claim 1, wherein the multiple solvents are selected from the group consisting of 1-(2-hydroxyethyl)-2-pyrrolidone, ethylhydroxy-propanediol, 2-methyl-1,3-propanediol, triethylene glycol, 1,5-pentandiol, 1,6-hexanediol, glycerol, and 5-dimethylhydantoin.

9. The ink composition of claim 1, wherein the dye is a sulfonated dye.

10. An ink set, comprising a cyan ink including a sulfonated cyan dye, a magenta ink including a sulfonated magenta dye, and a yellow ink including a sulfonated yellow dye, wherein the cyan ink, the magenta ink, and the yellow ink independently include an ink vehicle comprising:
water,
from 1.5 wt % to 8 wt % of a C4-C6 1,2-alkanediol,
from 12 wt % to 25 wt % of a secondary co-solvent package including multiple co-solvents selected from 2-pyrrolidone, 1-(2-hydroxyethyl)-2-pyrrolidone, 2-methyl-1,3-propanediol, triethylene glycol, 1,5-pentandiol, 1,6-hexanediol, glycerol, or 5-dimethylhydantoin, and
from 0.6 wt % to 1.6 wt % of a surfactant package including both a nonionic surfactant and an anionic surfactant at a weight ratio from 4:1 to 1.5:1.

11. The ink set of claim 10, wherein the cyan ink, the magenta ink, the yellow ink, or a combination thereof includes from 4 wt % to 12 wt % 1-(2-hydroxyethyl)-2-pyrrolidone, and from 4 wt % to 12 wt % of glycerol.

12. The ink set of claim 10, wherein the cyan ink, the magenta ink, yellow ink, or a combination thereof independently includes from 4 wt % to 12 wt % 1-(2-hydroxyethyl)-2-pyrrolidone, from 4 wt % to 12 wt % triethylene glycol, and from 1 wt % to 6 wt % tripropylene glycol methyl ether.

13. The ink set of claim 10, wherein the yellow ink includes from 1 wt % to 5 wt % betaine.

14. A method of printing, comprising:
ejecting a first portion of an ink composition from an inkjet printhead, wherein the ink composition includes a dye and an ink vehicle, the ink vehicle including:
water,
from 1.5 wt % to 8 wt % of a C4-C6 1,2-alkanediol,
from 12 wt % to 25 wt % of a secondary co-solvent package including multiple co-solvents selected from 2-pyrrolidone, 1-(2-hydroxyethyl)-2-pyrrolidone, 2-methyl-1,3-propanediol, triethylene glycol, 1,5-pentandiol, 1,6-hexanediol, glycerol, or 5-dimethylhydantoin,
from 0.6 wt % to 1.6 wt % of a surfactant package including both a nonionic surfactant and an anionic surfactant at a weight ratio from 4:1 to 1.5:1;
allowing the inkjet printhead to rest uncapped and unserviced for a time period 10 minutes or more; and
ejecting a second portion of the ink composition from the inkjet printhead, wherein the inkjet printhead is unclogged when the second portion is ejected.

15. The method of claim 14, wherein the ink composition is fed to the inkjet printhead from a fluid reservoir that includes a polyurethane foam in contact with the ink composition while the ink composition is within the fluid reservoir.
